(19) United States
(12) Patent Application Publication
(10) Pub. No.: US 2022/0187447 A1
(43) Pub. Date: Jun. 16, 2022

(54) IMAGING SENSOR AIR SHIELD

(71) Applicant: Continental Automotive Systems, Inc., Auburn Hills, MI (US)

(72) Inventor: Paul Vranjes, Santa Barbara, CA (US)

(73) Assignee: Continental Automotive Systems, Inc., Auburn Hills, MI (US)

(21) Appl. No.: 17/247,459

(22) Filed: Dec. 11, 2020

(51) Int. Cl. G01S 13/931; G01S 7/40

(52) U.S. Cl. CPC G01S 13/931; G01S 2007/4043; G01S 7/4004

(57) ABSTRACT

A detection device is equipped with a system to deliver pressurized fluid or compressed air or both to a lens or other optical surface to prevent or mitigate damage caused by the impact of debris. The detection device uses its own image detection function to track the trajectory of an object that might strike and impact the detection device. The detection device activates a burst of pressurized fluid or compressed air or both to shield or mitigate damage from impact. The detection device includes a housing, at least one surface mounted to the housing, and a spray device mounted to the housing. A medium, such as a liquid, gas, or compressed air, is selectively sprayed by the spray device. The spray device is activated to spray the medium when an object is approaching the surface, such that the trajectory of the object is altered when the object contacts the medium.

### FIELD OF THE INVENTION

The invention relates generally to a sensor unit which is equipped with a shielding function, where the sensor unit uses an image detection function to detect the trajectory of an object that may strike the sensor, and the sensor unit activates a burst of pressurized fluid or compressed air to act as a shield or mitigate damage from the impact of the object contacting the sensor unit.

### BACKGROUND OF THE INVENTION

As vehicles have become more advanced, an increased number of features have been implemented to detect objects around a vehicle. Autonomous driving vehicles and vehicles having various driving assist functions incorporate the use of various detection devices, such as sensors, radars, and the like.

These types of detection devices may have various lenses or other surfaces which may accumulate debris during travel of the vehicle, or may be impacted by objects such as rocks, ice, or the like, which have the potential to damage the components of the detection device. A rock or piece of ice impacting the lens or other surface may cause damage in the form of a crack, chip, or scratch, such that the lens or other surface of the detection device may be prevented from functioning properly, and prevented from detecting objects around the vehicle.

Accordingly, there exists a need to prevent or mitigate damage from an object hitting a detection device during the travel of a vehicle.

### SUMMARY OF THE INVENTION

In an embodiment, the present invention is a detection device is equipped with a system to deliver pressurized fluid or compressed air or both to a lens or other optical surface to prevent or mitigate damage caused by the impact of debris. The detection device uses its own image detection function to track the trajectory of an object that might strike and impact the detection device. Sensor activates high pressure burst of pressurized fluid or compressed air or both to shield or mitigate against damage from impact.

A detection device having a shielding function, the detection device having a housing, at least one surface mounted to the housing, and a spray device mounted to the housing. A medium is selectively sprayed by the spray device, and the spray device is activated to spray the medium when at least one object is approaching the surface, such that the trajectory of the object is altered when the object contacts the medium.

In an embodiment, the detection device has a plurality of lenses, and the spray device is able to spray the medium in multiple directions to alter the trajectory of the at least one object moving towards one or more of the lenses.

In an embodiment, the medium further is a liquid, in another embodiment, the medium is a gas, or air.

In an embodiment, the medium functions as a shield when the medium is sprayed by the spray device.

In an embodiment, the detection device is able to detect one or more objects while the medium is sprayed by the spray device.

In an embodiment, the spray device is activated when the object is a specified distance from the detection device.

In an embodiment, the spray device is activated when the object is at a specified distance from the detection device.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a detection device having a shielding function, according to embodiments of the present invention;

FIG. 2 is a top view of a detection device having a shielding function, according to embodiments of the present invention;

FIG. 3 is a second perspective view of a detection device having a shielding function, according to embodiments of the present invention; and

FIG. 4 is a side view of a detection device having a shielding function, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

A detection device having a shielding function is shown in the Figures generally at 10. The detection device 10 has at least one surface, and in the embodiment shown has multiple surfaces 12a,12b, and in this embodiment, each surface 12a,12b is a type of optical surface or a lens of a sensor. However, it is within the scope of the invention that the detection device 10 may be any type of detection device, such as a sensor, radar, LIDAR, camera, or the like. The lenses 12a,12b are mounted to a housing 14. Disposed in the housing 14 are various components used as part of the sensor. The housing 14 also includes an outer frame portion 16, and the outer frame portion 16 includes a central frame member 18.

Mounted to the central frame member 18 is a spray device 20. The spray device 20 may be a type of nozzle, or any other suitable component which is able to spray some type of medium, such as liquid or air, in a desired pattern or direction. The spray device 20 is in fluid communication with some type of a tank or other container which stores the medium, and a pump device, which is able to transfer the medium to the spray device 20.

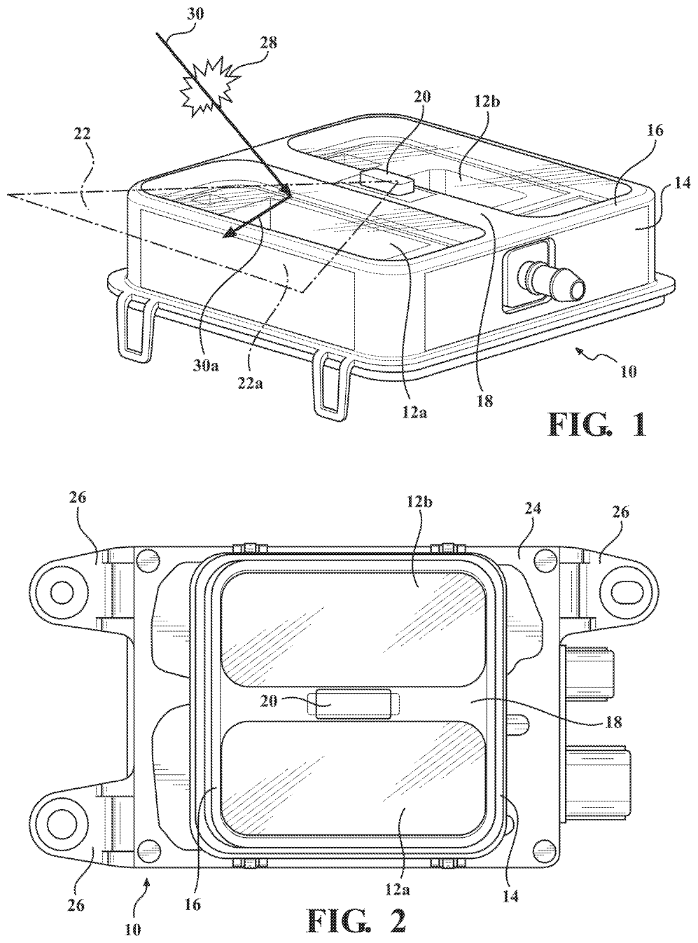

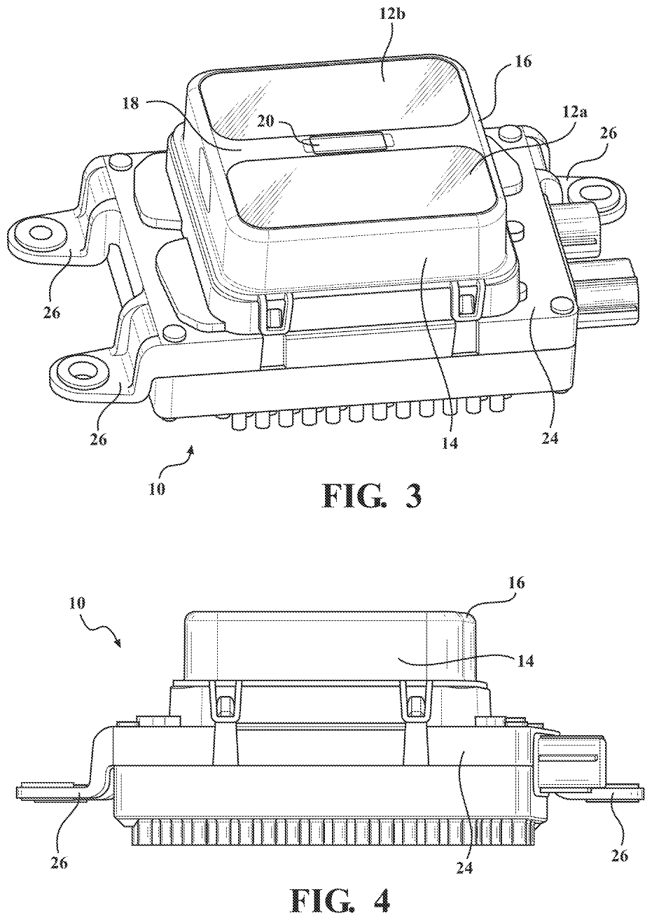

The spray device 20 is able to distribute the medium in a desired pattern, as shown in FIG. 1. The medium shown in FIG. 1 is a liquid 22, but it is within the scope of the invention that a gas, or compressed air may be used as well.

The housing 14 is mounted to a sub-housing 24, and the sub-housing 24 has various flanges 26 which are used for mounting the detection device 10 to a vehicle, such as an autonomous driving vehicle, in a desired location.

The detection device 10 is used to detect various objects around a vehicle, such as an autonomous driving vehicle. When the vehicle is moving, there may be situations where various objects or debris contact the detection device 10. The objects or debris moving towards the vehicle may be the result of wind blowing the objects towards the vehicle, or an object such as a rock may be propelled towards the detection device 10 from another vehicle. If the object or debris contacts one or more of the lenses 12a,12b, this may result in one or both of the lenses 12a,12b being cracked, chipped, or scratched, such that the detection device 10 may be prevented from functioning properly.

The detection device 10 of the present invention has a shielding function, where the medium 22 is sprayed to function as a shield and prevents an object from contacting either of the lenses 12a,12b. An object 28 is shown in FIG. 1 which is moving towards the lens 12a, the object 28 has a trajectory 30. Without the use of the shielding function, the object 28 would contact the lens 12a, and potentially damage the lens 12a.

However, the shielding function is able to reduce or completely prevent the object 28 from contacting the lens 12a. During the operation of the vehicle, the detection device 10 is used to detect pedestrians, street signs, traffic signals, other vehicles and the like. The detection device 10 of the present invention is also able to detect objects such as the object 28 shown in FIG. 1, which may be a rock, a piece of ice, or other type of debris. When the detection device 10 detects that the object 28 is approaching the lens 12a, the spray device 20 is activated to spray the liquid 22 in the pattern shown in FIG. 1, such that the liquid 22 being sprayed functions as a shield 22a. The liquid 22 is sprayed with enough pressure to have an effect on the trajectory 30 of the object 28. After the object 28 is in contact with the liquid 22, the object 28 follows an altered trajectory 30a, and is either prevented from contacting the lens 12a, as shown in FIG. 1, or the impact of the object 28 contacting the lens 12a is reduced or eliminated.

Once the trajectory 30 of the object 28 has been altered, the spray device 20 is deactivated, such that the liquid 22 is no longer being sprayed from the spray device 20.

The spray pattern in the embodiment shown is triangular-shaped, but it is within the scope of the invention that the spay pattern may be other shapes including, but not limited to, conical, square-shaped, or any other pattern suitable to function as a shield to protect the lens 12a from various objects contacting the lens 12a.

In another embodiment, the spray device 20 may also have an additional nozzle or outlet such that the spray device 20 has the ability to spray the liquid 22 in a direction to alter the trajectory and prevent or reduce the impact of an object contacting the other lens 12b. The spray device 20 therefore is able to spray the liquid 22 in multiple directions. In another embodiment, the spray device 20 may be connected to a motor or other device which may vary the position of the spray device 20, such that the spray device 20 may pivot for example, allowing the spray device 20 to spray the liquid 22 is various directions to protect the lens 12a from objects having a wide range of possible trajectories.

In another embodiment, there are multiple spray devices having one or more nozzles used to spray the liquid 22 in various directions alternately or simultaneously. Additionally, each of these multiple spray devices may be connected to a motor, or different motors, to vary the position of each spray device, such that each of the multiple spray devices is able to spray the liquid 22 in varying directions.

The spray device 20 may be controlled by a controller (not shown), where the controller is used to control both the spray device 20 and the operation of the detection device 10. The controller is able to control the timing of the activation of the spray device 20 such that the spray device 20 is activated when the object 28 is within a specified distance from the lens 12a. The specified distance may vary depending upon the velocity of the object 28 moving towards the lens 12a. The controller activates the spray device 20 such that the shield 22a is created prior to the object 28 contacting the lens 12a.

The detection device 10 is also able to function continuously whether the spray device 20 is activated or deactivated and when detecting the object 28 or other objects. The detection device 10 uses its own object detection function to detect the object 28 or other objects moving towards the lens 12a. The detection device 10 is able to detect the object 28, as well as other objects, such as other vehicles, pedestrians, street signs, traffic signals, and the like, while the spray device 20 is activated, and the liquid 22 is being discharged from the spray device 20.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a detection device, including:
at least one surface;
at least one spray device located in proximity to the at least one surface;
a medium which is selectively sprayed by the spray device;
a shield formed by the medium being sprayed by the spray device; and
a shielding function, the detection device performs the shielding function when the spray device is activated to spray the medium to create the shield when at least one object is approaching the at least one surface, such that the trajectory of the at least one object is altered when the at least one object contacts the shield.

2. The pressure sensor of claim 1, the detection device further comprising:
a housing, the at least one surface mounted to the housing;
wherein the at least one spray device is mounted to the housing in proximity to the at least one surface.

3. The pressure sensor of claim 1, the at least one surface further comprising a plurality of surfaces, wherein the spray device is able to spray the medium in multiple directions to alter the trajectory of the at least one object moving towards one of the plurality of surfaces.

4. The apparatus of claim 1, the medium further comprising one selected from the group consisting of liquid or gas.

5. The apparatus of claim 1, wherein the detection device able to detect one or more objects while the medium is sprayed by the spray device.

6. The apparatus of claim 1, wherein the at least one spray device is activated when the at least one object is at a specified distance from the detection device.

7. A detection device having a shielding function, comprising:
a housing;
at least one surface mounted to the housing;
a spray device mounted to the housing; and
a medium which is selectively sprayed by the spray device;
wherein the spray device is activated to spray the medium when at least one object is approaching the at least one surface, such that the trajectory of the at least one object is altered when the at least one object contacts the medium.

8. The detection device having a shielding function of claim 7, the least one surface further comprising a plurality of lenses, wherein the spray device is able to spray the medium in multiple directions to alter the trajectory of the at least one object moving towards one of the plurality of lenses.

9. The detection device having a shielding function of claim 7, the medium further comprising one selected from the group consisting of liquid or gas.

10. The detection device having a shielding function of claim 7, the medium further comprising a shield when the medium is sprayed by the spray device.

11. The detection device having a shielding function of claim 7, wherein the detection device able to detect one or more objects while the medium is sprayed by the spray device.

12. The detection device having a shielding function of claim 7, wherein the at least one spray device is activated when the object is at a specified distance from the detection device.
